(19) United States
(12) Patent Application Publication
(10) Pub. No.: US 2010/0124876 A1
(43) Pub. Date: May 20, 2010

(54) AIR DUCT OUTLET

(76) Inventors: Edilbert Yu, Ajax (CA); Felix Chang, North York (CA); Thomas Gehring, Toronto (CA); Michael W. Cass, Rochester, MI (US)

Correspondence Address: INTERNATIONAL AUTOMOTIVE COMPONENTS GROUP, LLC;c/o MACMILLAN, SOBANSKI & TODD, LLC, ONE MARITIME PLAZA, FIFTH FLOOR, 720 WATER STREET, TOLEDO, OH, 43604, US

(21) Appl. No.: 12/274,712

(22) Filed: Nov. 20, 2008

(51) Int. Cl. B60H 1/34

(52) U.S. Cl. 454/155

(57) ABSTRACT

An air duct outlet is disclosed herein. The air duct outlet includes a housing comprising a first wall being substantially planar and a second wall being at least partially convex to the first wall. The first wall and the second wall are disposed in adjacent, spaced-apart relation and defining at least two sides of an air passageway. The air passageway extends along a flow path between an inlet and a flared outlet. The air duct outlet also includes a vane pivotally disposed within the air passageway along the flow path. The vane is movable between a first position wherein the vane substantially blocks the air passageway and a range of other positions that are increasingly substantially parallel to the first wall. An air stream flowing through the air passageway is deflected by the vane an amount that decreases with each position more remote of the first position over the range such that the air stream adheres to the second wall by an amount that increases with each position more remote of the first position over the range. Also, the air stream exits from the air duct outlet in a direction that is increasingly transverse to the first wall as the vane moves away from the first position.

### BACKGROUND OF THE INVENTION

This invention relates in general to an outlet for an air duct and more particularly to an outlet configured to apply the Coanda effect. U.S. Pat. No. 6,902,474, discloses an air duct outlet with single vane air stream direction control. With the reference to the drawings and reference numerals of the '474 patent, an air duct outlet (10) includes a housing (12) comprising a first wall (18) and a convexly-curved second wall (20 or 22) that are in adjacent, spaced-apart relationship. The first wall (18) and the second wall (20 or 22) define an air passageway (24 or 26) having an inlet (24a or 26a) and a flared outlet (24b or 26b). The air duct outlet (10) also includes a vane (30 or 32) pivotally attached within the air passageway (24 or 26). The vane (30 or 32) is movable between a first position wherein the vane (30 or 32) is disposed in face-to-face adjacent relationship with the first wall (18) and a range of positions that are increasingly transverse to the first wall (18). An air stream flowing through the air passageway (24 or 26) is deflected by an amount that increases with each position of the vane (30 or 32) in the range such that the air stream adheres to a portion of the second wall (20 or 22) by an amount that increases with each position of the vane (30 or 32) in the range. Also, the air stream exits from the outlet (24b or 26b) in a direction that is increasingly transverse to a direction normal to the outlet (24b or 26b).

### SUMMARY OF THE INVENTION

In summary, the invention is an air duct outlet. The air duct outlet includes a housing comprising a first wall being substantially planar and a second wall being at least partially convex to the first wall. The first wall and the second wall are disposed in adjacent, spaced-apart relation and defining at least two sides of an air passageway. The air passageway extends along a flow path between an inlet and a flared outlet. The air duct outlet also includes a vane pivotally disposed within the air passageway along the flow path. The vane is movable between a first position wherein the vane substantially blocks the air passageway and a range of other positions that are increasingly substantially parallel to the first wall. An air stream flowing through the air passageway is deflected by the vane an amount that decreases with each position more remote of the first position over the range such that the air stream adheres to the second wall by an amount that increases with each position more remote of the first position over the range. Also, the air stream exits from the air duct outlet in a direction that is increasingly transverse to the first wall as the vane moves away from the first position.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an exemplary embodiment of the invention in an exemplary operating environment;

FIG. 2 is an exploded view of the exemplary embodiment of the invention shown in FIG. 1;

FIG. 3 is a simplified cross-sectional view taken along section lines 3-3 in FIG. 1; and

FIG. 4 is an illustration of the performance of the exemplary embodiment of the invention.

### DETAILED DESCRIPTION OF THE EXEMPLARY EMBODIMENT

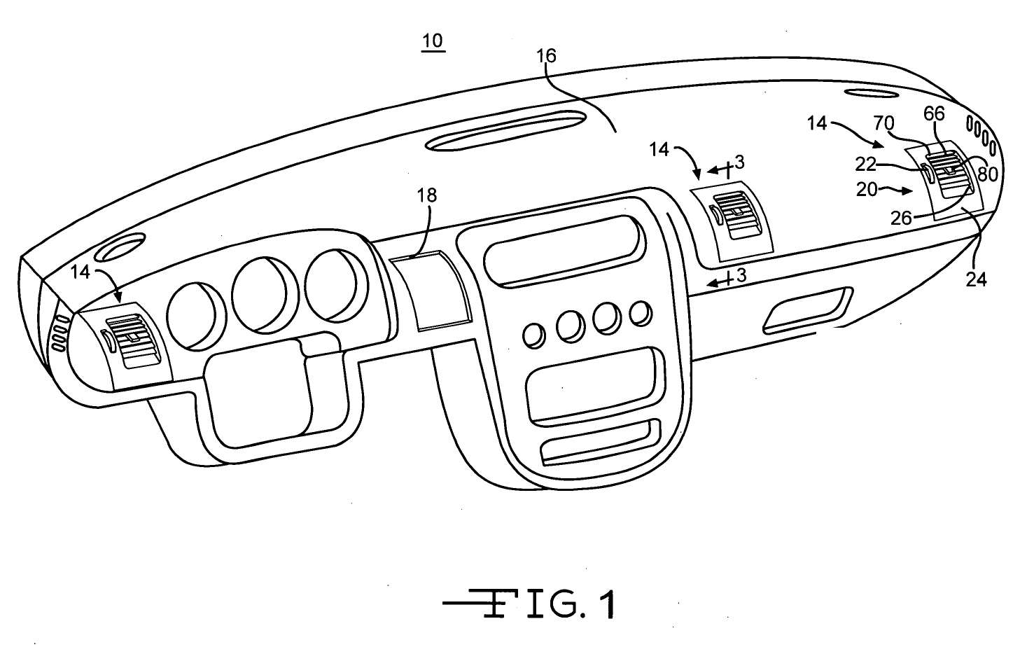

FIG. 1 shows an interior 10 of a vehicle in which the exemplary embodiment of the invention is incorporated. An air duct outlet 14 according to an exemplary embodiment of the invention is shown positioned adjacent to a dashboard 16 in the vehicle. The dashboard 16 is exposed in the interior 10 of the vehicle and defines a first aperture 18. The air duct outlet 14 can direct air to flow through the aperture 18. A register 20 can be engaged with respect to the aperture 18 to enhance the aesthetic appearance of the intersection of the air duct outlet 14 and the aperture 18. The register 20 can also support structures for closing the air duct outlet 14, such as a knob 22. The operation of the knob 22 in closing the air duct outlet 14 will be discussed below. The register 20 can include a frame 24 supporting the knob 22 for pivoting movement and can also define a second aperture 26. Air passing out of the air duct outlet 14 can pass into the interior 10 of the vehicle through the aperture 26.

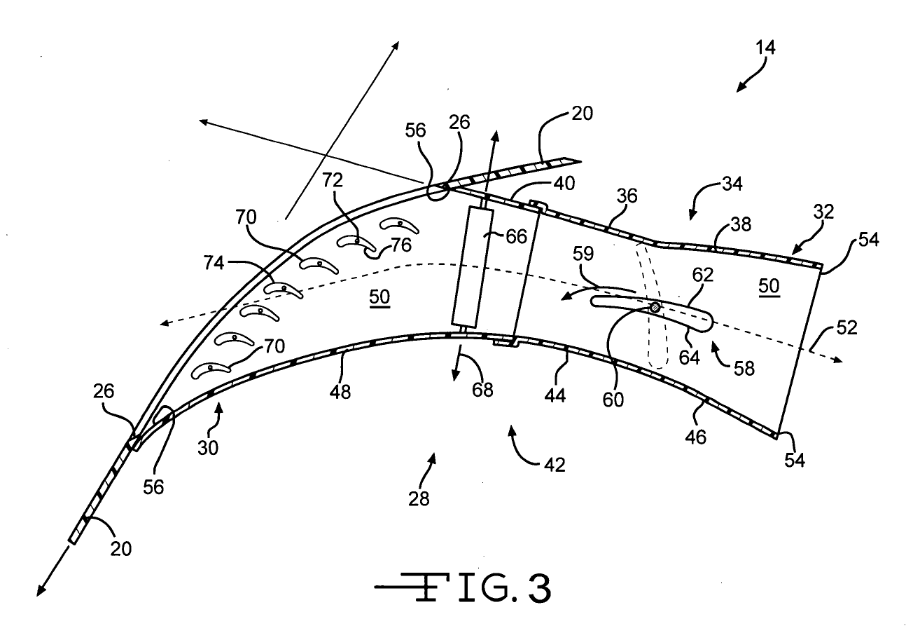

Referring now to FIG. 3, the air duct outlet 14 includes a housing 28. The exemplary housing 28 is formed from first and second housing members 30, 32 connected together. In alternative embodiments of the invention, the housing 28 may be formed as single, integral structure or may be formed from more than two housing members.

The housing 28 includes a first wall 34 that is substantially planar. The first wall 34 need not be perfectly planar in all embodiments of the invention. As shown by the Figures, the exemplary first wall 34 includes a first and second portions 36, 38 that are at a slight angle to one another. The first and second portions 36, 38 are integral with one another, defined by the second housing member 32. The first wall 34 also includes a third portion 40 defined by the first housing member 30. The first and third portions 36, 40 of the first wall 34 are substantially coplanar.

The housing 28 also includes a second wall 42 that is at least partially convex to the first wall 34. The exemplary second wall 42 includes a first and second portions 44, 46 that are at a slight angle to one another. The first and second portions 44, 46 of the second wall 42 are integral with one another, defined by the second housing member 32. The second wall 42 also includes a third portion 48 defined by the first housing member 30. The exemplary third portion 48 of the second wall 42 can diverge away steeply from the plane of the first portion 44 of the second wall 42.

The first wall 34 and the second wall 42 are disposed in adjacent, spaced-apart relation and define at least two sides of an air passageway 50 that extends along a generalized flow path represented by an axis 52. In the exemplary embodiment of the invention, the first wall 34 and the second wall 42 define top and bottom guide surfaces of the air passageway 50. However, in alternative embodiments of the invention, the structures could be inverted such that the first wall 34 and the second wall 42 define lateral sides of the air passageway 50. It is noted that the illustrated axis 52 is positioned directly between the first wall 34 and the second wall 42 along its length and does not necessarily represent the movement of air.

The air passageway 50 extends between an inlet 54 and a flared outlet 56. Along the axis 52 between the second portion 38 of the first wall 34 and the second portion 46 of the second wall 42, the air passageway 50 converges slightly. This aspect of the air passageway 50 can be desirable to increase the likelihood that air stream flowing through the air passageway 50 will be fully laminar prior to traveling further downstream. Along the axis 52 between the first portion 36 of the first wall 34 and the first portion 44 of the second wall 42, the air passageway 50 maintains a substantially constant cross-sectional area. This aspect of the air passageway 50 can be desirable to maintain laminar flow of the air stream passing through the air passageway 50. Along the axis 52 between the third portion 40 of the first wall 34 and the third portion 48 of the second wall 42, the cross-sectional area of air passageway 50 increases. The exemplary second wall 42 extends a greater distance than the exemplary first wall 34 between the inlet 54 and the outlet than the first wall 34. Also, the exemplary second wall 42 extends a greater distance from a downstream end of the first portion 44 to the outlet 56 than the distance that the first wall 34 extends from a downstream end of the first portion 36 to the outlet 56.

Based on the structure described above, in the exemplary embodiment of the invention, the first wall 34 and the second wall 42 are closer to parallel at the inlet 54 than at the outlet 56. In the exemplary embodiment of the invention, the first wall 34 and the second wall 42 are transverse at the outlet 56, fully perpendicular or less than perpendicular. FIG. 3 also shows that a downstream end of the first wall 34, the end of the first wall 34 at the outlet 56 is recessed relative to a downstream end of the second wall 42 such that the downstream end of the first wall 34 is spaced from a line extending tangent to the downstream end of the second wall 42. This aspect of the exemplary structure can be desirable if the dashboard of the vehicle is especially laid-back.

The air duct outlet 14 also includes a vane 58 pivotally disposed within the air passageway 50 along the flow path. The vane 58 is movable between a first position (shown in phantom) wherein the vane 58 substantially blocks the air passageway 50. The first position of the vane 58 (shown in phantom) can be an end limit of movement. It is noted that the “first position” of the vane 58 need not be an end limit of travel of the vane 58 in alternative embodiments of the invention.

The vane 58 can be moved through a range of other positions away from the first position that are increasingly substantially parallel to the planar first wall 34. In the exemplary embodiment of the invention, the vane 58 is rotatable about a pivot axis 60 and wherein the first position and the other positions are further defined as angular positions about the pivot axis 60.

FIG. 3 shows an exemplary position of the vane 58 is solid line that can be a second end limit of movement. As the vane 58 moves further from the first position toward an opposite end limit of movement, the air stream flowing through the air passageway 50 is deflected by the vane 58 an amount that decreases with each position more remote of the first position over the range. For example, when the vane 58 is in the position shown by phantom line in FIG. 3, the vane 58 is deflecting the air stream a maximum amount. In such a position, the vane 58 is deflecting to the point of blocking the air stream.

On the other hand, when the vane 58 is in the position shown by solid line in FIG. 3, the vane 58 is deflecting the air stream a minimum amount. The vane 58 is disposed in the air stream, so as theoretical matter some deflecting will occur. However, when the vane 58 is in the position shown by solid line in FIG. 3, the vane 58 is essentially drawing at least part of the air stream in a desired direction through the Coanda effect rather than deflecting the air steam. An arrow 59 represents the drawing of air over the vane 58 in manner consistent with the Coanda effect.

The air stream can adhere to the second wall 42 by an amount that increases with each position more remote of the first position over the range and such that the air stream exits from the air duct outlet 14 in a direction that is increasingly transverse to the planar first wall 34 as the vane 58 moves away from the first position. Thus, when the vane 58 is in the position shown in solid line in FIG. 3, the air flow will adhere to the second wall 42 a maximum amount. When the vane 58 is in the position shown in phantom line in FIG. 3, the air flow will adhere to the second wall 42 a minimum amount.

The vane 58 can include a cross-sectional profile in a plane perpendicular to the flow path that includes at least one arcuate surface. The cross-sectional profile of the exemplary vane 58 includes a first arcuate surface 62 confronting and convex to the first wall 34. The cross-sectional profile of the exemplary vane 58 also includes a second arcuate surface 64 confronting and concave to the second wall 42.

The air duct outlet 14 can also include a plurality of louvers pivotally disposed in the air passageway 50 downstream of the vane 58. One or more or all of the louvers can have the same cross-sectional profile as the vane 58 or can have different cross-sectional profiles. The exemplary air duct outlet 14 includes a first set of louvers 66 arranged side-by-side across the air passageway 50. Each of the first set of louvers 66 can be pivotal about a respective axis 68 extending perpendicular to the flow path.

The exemplary air duct outlet also includes a second set of louvers 70 downstream of the first set of louvers 66 and arranged side-by-side across the air passageway 50. Each of the second set of louvers 70 can be pivotal about a respective axis 72 extending perpendicular to the flow path. The axes 68 of the first set of louvers 66 are transverse to the axes 72 of the second set of louvers 70. The exemplary louvers 66 can be arranged vertically and the exemplary louvers 70 can be arranged horizontally.

Each of the second set of louvers 70 can include a cross-sectional profile perpendicular to the flow path with first arcuate surface 74 confronting and convex to the first wall 34 and a second arcuate surface 76 confronting and concave to the second wall 42. Each of the first set of louvers 66 can include a cross-sectional profile that is substantially planar.

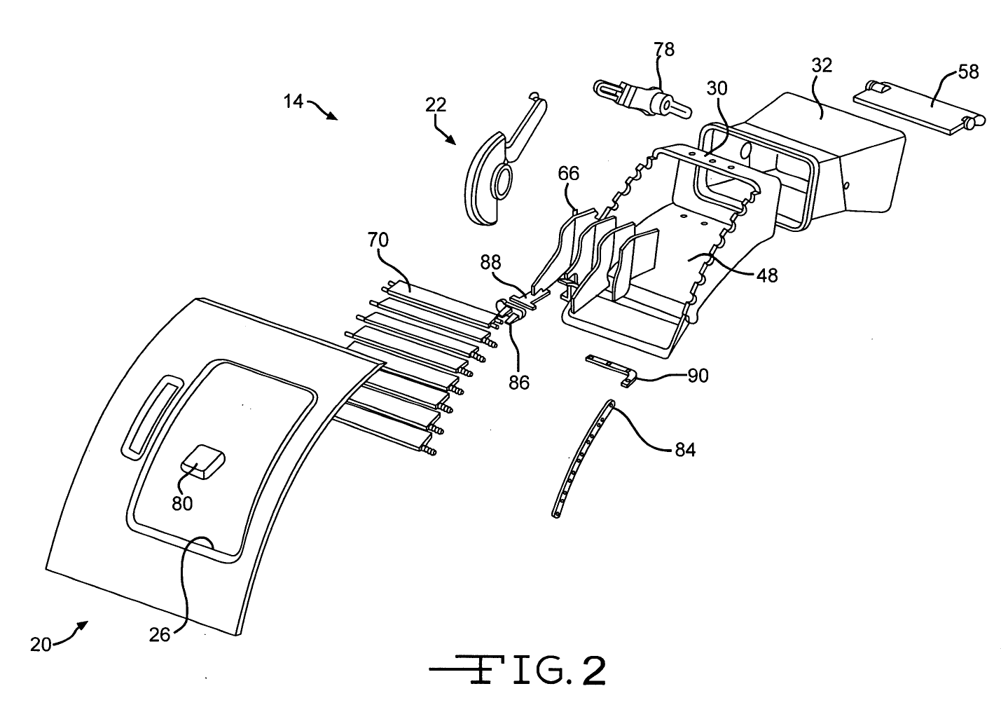

Referring now to FIG. 2, the air duct outlet 14 can control a flow of air into the interior 10 (shown in FIG. 1) of the vehicle. When it is desired to change flow characteristics, the knob 22 can be engaged. If the flow is occurring, the knob 22 can be pivoted to stop the air flow. As shown in FIG. 2, the knob 22 is coupled to the vane 58 though a linkage 78. The vane 58 can move through the range of positions in response to movement of the knob 22. The louvers 66 and 70 can be moved between end limits of travel to define a range positions from relatively more open to relatively more closed. Movement of both sets of louvers 66, 70 can be accomplished through a knob 80. The knob 80 can be directly mounted on one of the louvers 70 and can be grasped by a vehicle occupant to pivot the louver 70 about its axis of rotation. A linkage 84 can couple all of the louvers 70 together such that pivoting movement of the louver 70 engaged with the knob 80 results in pivoting movement of all the louvers 70.

The knob 80 can be directly mounted on one of the louvers 70 for sliding movement in a transverse direction. The knob can also be coupled to the louvers 66 a fork attachment 86 and a fork 88. Lateral sliding movement of the knob 80 can cause one of the louvers 66 to pivot about its axis of rotation through the fork attachment 86 and the fork 88. A linkage 90 can couple all of the louvers 66 together such that pivoting movement of the louver 66 engaged with the knob 80 results in pivoting movement of all the louvers 66.

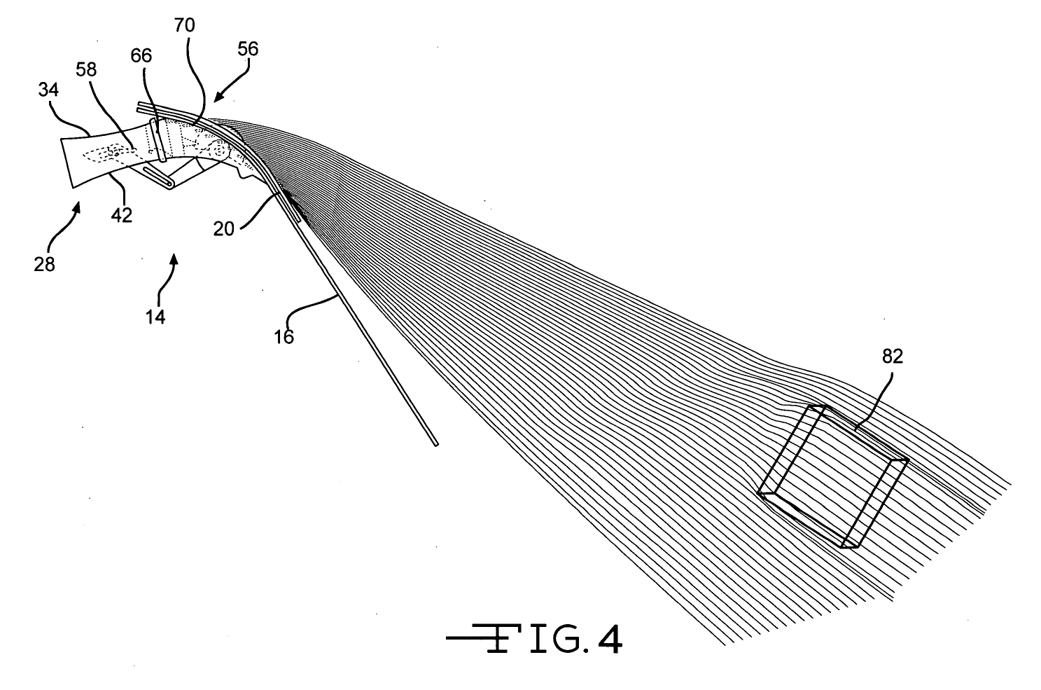

FIG. 4 shows the operation of the exemplary air duct outlet 14 and also shows the air stream moving in pattern referred to as the Coanda effect. A cubic form 82 represents the desired target for the air flow. The air duct outlet 14, by the cooperative action of the vane 58, the louvers 66, the louvers 70, and inner surfaces of the housing 28, cause the air stream to bend and flow towards the cubic form 82. As shown in FIG. 4, the second wall 42 is tangent to the dashboard 16 at the outlet 56. Also, the first wall 34 is substantially horizontal in the vehicle. As set forth above, alternative embodiments of the invention could be rotated ninety degrees or any other angle. The rotation can result in horizontal or vertical positioning and either set of louvers can be disposed in horizontal or vertical positions when closed or opened.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An air duct outlet comprising:
a housing comprising a first wall being substantially planar and a second wall being at least partially convex to said first wall, said first wall and said second wall being disposed in adjacent, spaced-apart relation and defining at least two sides of an air passageway extending along a flow path between an inlet and a flared outlet; and
a vane pivotally disposed within said air passageway along said flow path and movable between a first position wherein said vane substantially blocks said air passageway and a range of other positions that are increasingly substantially parallel to said first wall, wherein an air stream flowing through said air passageway is deflected by said vane an amount that decreases with each position more remote of said first position over said range such that the air stream adheres to said second wall by an amount that increases with each position more remote of said first position over said range and such that the air stream exits from said air duct outlet in a direction that is increasingly transverse to said first wall as said vane moves away from said first position.

2. The air duct outlet of claim 1 wherein said vane includes a cross-sectional profile perpendicular to said flow path that includes at least one arcuate surface.

3. The air duct outlet of claim 2 wherein said cross-sectional profile of said vane includes an arcuate surface confronting and convex to said first wall.

4. The air duct outlet of claim 2 wherein said cross-sectional profile of said vane includes an arcuate surface confronting and concave to said second wall.

5. The air duct outlet of claim 2 wherein said cross-sectional profile of said vane includes:
a first arcuate surface confronting and convex to said first wall; and
a second arcuate surface confronting and concave to said second wall.

6. The air duct outlet of claim 1 wherein said vane is rotatable about a pivot axis and wherein said first position and said other positions are further defined as angular positions about said pivot axis.

7. The air duct outlet of claim 1 further comprising:
a plurality of louvers pivotally disposed in said air passageway downstream of said vane.

8. The air duct outlet of claim 7 wherein at least some of said plurality of louvers includes a cross-sectional profile perpendicular to said flow path and having a first arcuate surface confronting and convex to said first wall and a second arcuate surface confronting and concave to said second wall.

9. The air duct outlet of claim 7 wherein said plurality of louvers further comprise:
a first set of louvers arranged side-by-side across said air passageway, each of said first set of louvers pivotal about a respective axis extending perpendicular to said flow path; and
a second set of louvers downstream of said first set of louvers and arranged side-by-side across said air passageway, each of said second set of louvers pivotal about a respective axis extending perpendicular to said flow path, wherein said axes of said first set of louvers are transverse to said axes of said second set of louvers.

10. The air duct outlet of claim 9 wherein each of said second set of louvers includes a cross-sectional profile perpendicular to said flow path and having a first arcuate surface confronting and convex to said first wall and a second arcuate surface confronting and concave to said second wall.

11. The air duct outlet of claim 10 wherein each of said first set of louvers includes a cross-sectional profile perpendicular to said flow path being substantially planar.

12. The air duct outlet of claim 1 wherein said second wall extends a greater distance between said inlet and said outlet than said first wall.

13. The air duct outlet of claim 1 wherein said first wall and said second wall are closer to parallel at said inlet than said flared outlet and are transverse to one another at said flared outlet.

14. The air duct outlet of claim 13 wherein a downstream end of said first wall is recessed relative to a downstream end of said second wall such that said downstream end of said first wall is spaced from a line extending tangent to said downstream end of said second wall.

15. The air duct outlet of claim 1 wherein said housing is shaped to define said air passageway to include a first portion along said flow path of substantially constant cross-sectional area and a second portion along said flow path of increasing cross-section.

16. The air duct outlet of claim 15 wherein said vane is positioned along said flow path upstream of said second portion.

17. The air duct outlet of claim 16 wherein said vane is positioned along said flow path at least partially upstream of said first portion.

18. A vehicle comprising:
a dashboard exposed in an interior of said vehicle and defining a first aperture;
a register engaged with respect to said first aperture and having a frame defining a second aperture;
a housing comprising a first wall being substantially planar and a second wall being at least partially convex to said first wall, said first wall and said second wall being disposed in adjacent, spaced-apart relation and defining at least two sides of an air passageway extending along a flow path between an inlet and a flared outlet adjacent said second aperture of said register; and
a vane pivotally disposed within said air passageway along said flow path and movable between a first position wherein said vane substantially blocks said air passageway and a range of other positions that are increasingly substantially parallel to said first wall, wherein an air stream flowing through said air passageway is deflected by said vane an amount that decreases with each position more remote of said first position over said range such that the air stream adheres to said second wall by an amount that increases with each position more remote of said first position over said range and such that the air stream exits from said air duct outlet in a direction that is increasingly transverse to said first wall as said vane moves away from said first position.

19. The vehicle of claim 18 wherein said second wall is tangent to said dashboard at said outlet.

20. The vehicle of claim 18 wherein said first wall is substantially horizontal.
